(19) United States
(12) Patent Application Publication
(10) Pub. No.: US 2003/0003591 A1
(43) Pub. Date: Jan. 2, 2003

(54) Reaction vessel

(75) Inventors: Michael W. LaCourt, Spencerport, NY (US); Thomas C. Arter, Rochester, NY (US)

Correspondence Address: WALL MARJAMA & BILINSKI, 101 SOUTH SALINA STREET, SUITE 400, SYRACUSE, NY, 13202, US

(73) Assignee: Ortho-Clinical Diagnostics, Inc.

(21) Appl. No.: 09/897,673

(22) Filed: Jul. 2, 2001

(51) Int. Cl. G01N 21/03

(52) U.S. Cl. 436/165; 422/102; 422/63; 422/82.05; 422/82.09; 436/43; 436/47

(57) ABSTRACT

A reaction vessel for use in a clinical analyzer includes a frame having a plurality of vertically disposed reaction chambers in spaced relation, each of the reaction chambers being sized for retaining a volume of at least one fluid. The vessel further includes at least one gap region defined between at least one adjacent pair of reaction chambers for thermally affecting the fluid contents therein.

### FIELD OF THE INVENTION

The invention relates to the field of patient sample measurement, and more particularly to a vessel having adjacent reaction wells which are effectively thermally isolated from one another, the vessel being utilized to perform multiple wet assays.

### BACKGROUND OF THE INVENTION

Reaction vessels or cuvettes are known in the field of “wet” chemistry clinical analysis systems for retaining a plurality of patient samples and other fluids for the preparation and conduction of various types of assays.

As described in U.S. Pat. No. 4,690,900 to Kimmo et al., these vessels typically include a support fixture having a plurality of adjacently disposed reaction wells, each of the wells being sized to retain a volume of a metered fluid, such as patient sample, diluent, reagent(s), and/or calibration fluids. As described in the above referred to '900 patent, the fluid(s) retained in each of the reaction chambers can be tested as needed by apparatus, such as a spectrophotometer, through a transparent window provided in the side walls of the vessel.

A problem generally known to those in the field of patient sample measurement is that heat transfer will take place between adjacent chambers of a reaction vessel which conducts multiple wet assays. Such thermal effects influence not only the confidence in testing using the vessel, but also the overall throughput of a clinical analysis apparatus used in conjunction therewith.

Therefore, there is a general need in the field to minimize the thermal effects between individual samples within a reaction vessel or cuvette; that is, to be able to thermally insulate the fluid contents within a vessel which contains a plurality of adjacently disposed reaction wells or chambers.

There is another general need in the field to improve the manner in which sample or other fluid is dispensed into one or more reaction chambers of a reaction vessel, such as those previously described above.

### SUMMARY OF THE INVENTION

It is a primary object of the present invention to overcome the above-noted problems associated with the prior art.

It is another primary object of the present invention to provide a reaction vessel or cuvette for processing of wet assays in which the fluid contents of adjacent reaction chambers of the vessel are thermally insulated from one another.

It is yet another primary object of the present invention to provide a reaction vessel which permits greater controlled aspiration and dispensing of fluids used in the conduction of wet assays.

It is still a further primary object of the present invention to provide greater throughput for clinical analytical apparatus in which wet assays are performed.

Therefore and according to a preferred aspect of the invention, there is provided a reaction vessel comprising:

a) a frame including a plurality of vertically disposed reaction chambers held in spaced relation, each of said reaction chambers being sized for retaining a volume of at least one fluid; and

b) means disposed between at least two adjacent reaction chambers for thermally affecting the fluid contents thereof.

The thermal affecting means according to a preferred embodiment includes at least one gap region which is defined between at least two adjacent reaction chambers of the reaction vessel. Preferably, the gap region includes at least one air or evacuated gap that prevents or at least substantially minimizes migratory or transient thermal effects to therefore provide improved insulation for the fluid contents of the vessel.

According to a preferred embodiment, the lower portion of each reaction chamber of the herein described vessel is smaller than the upper portion, the reaction chamber being sized to receive a fluid dispensing or aspirating member, such as a tapered disposable metering tip, which can aspirate fluid from or dispense fluid to a reaction chamber.

Preferably, the reaction chambers each include at least one pair of optically transmissive windows, preferably located in the lower portion of each reaction chamber of the vessel, which allows spectrophotometric or other form of optical testing to be performed on a retained fluid sample.

The thermal affecting means can also be used to conduct heat more readily to at least one reaction chamber of the herein described vessel. For example, an adapter block made from a thermally conductive material can be placed into at least one of the defined gap regions. When inserted into an incubator, thermal transfer readily occurs between the reaction chambers adjacent the gap region containing the thermally conductive adapter block. Alternately, the incubator can be configured to engage the gap regions of the reaction vessel directly so as to selectively apply heat directly to any number of thermal chambers of the vessel.

According to yet another preferred aspect of the invention, there is provided a reaction vessel for use in a clinical analyzer, said reaction vessel comprising a frame including a plurality of vertically disposed reaction chambers in spaced relation, each of said reaction chambers being sized for retaining a volume of fluid and means disposed between at least two of said chambers for thermally insulating the fluid contents in at least one pair of reaction chambers.

Preferably, the thermal insulating means can include at least one gap region disposed between at least one pair of the reaction chambers.

In addition, at least one of the reaction chambers is sized to receive a fluid dispensing/aspirating member, such as a pipette tip in order to dispense fluid into a reaction chamber directly or to aspirate fluid therefrom. According to a preferred embodiment, the fluid dispensing/aspirating member is a disposable tapered metering tip.

The cuvette is preferably made from a plastic material and includes at least one transparent window pair to permit optical testing of fluid sample contained in at least one of the reaction chambers of the vessel.

According to yet another preferred aspect of the present invention, there is provided a clinical analyzer comprising a wet chemistry analysis system and at least one reaction vessel for retaining at least one fluid sample. The reaction vessel includes a plurality of reaction chambers, each of the chambers having defined therebetween thermal affecting means which insulates the fluid contents of the reaction chambers or enables thermal transfer to occur readily to or between reaction chambers when used in conjunction with an incubator of the analyzer.

According to yet another preferred aspect of the invention, there is described a method for testing a patient sample, said method comprising the steps of:

a) providing a reaction vessel having a plurality of adjacent reaction chambers,

b) aspirating a fluid into a fluid aspirating/dispensing member;

c) introducing said fluid aspirating/dispensing member into a lower portion of a reaction chamber; and

d) dispensing fluid directly into the lower portion of the reaction chamber of said vessel.

Preferably, fluid, such as patient sample, reagents, or calibration liquids, can also be selectively aspirated from a reaction chamber, also preferably using a fluid aspirating/dispensing member, such as a tapered metering tip, which is lowered into a reaction chamber.

An advantageous feature of the present invention is that multiple fluid volumes which are contained within a reaction vessel in separate reaction chambers of the vessel can be thermally isolated from one another.

Another advantage of the present invention is that each of the reaction chambers of the reaction vessel can be used to receive a metering tip to either aspirate or dispense sample or other fluids therefrom.

Yet another advantage of the present invention is that overall throughput can be effectively increased using a reaction vessel, such as described herein, in a clinical analyzing apparatus.

These and other objects, features, and advantages will become readily apparent from the following Detailed Description which should be read in conjunction with the following drawings.

### BRIEF DESCRIPTION OF THE DRAWINGS

FIG. 1 is a side elevational view, partly in section, of a reaction vessel made in accordance with the prior art;

FIG. 2 is a side elevational view of the prior art reaction vessel of FIG. 1 as used in conjunction with an optical testing apparatus;

FIG. 3 is a top view of a reaction vessel made in accordance with a first embodiment of the present invention;

FIG. 4 is a sectioned front perspective view of the reaction vessel of FIG. 3;

FIG. 5 is a side sectional view of the reaction vessel of FIG. 4 including a metering tip which can be fitted into a reaction well of the vessel;

FIG. 6 is a side elevational view, in section, of a reaction vessel in accordance with a second embodiment of the present invention;

FIG. 7 is a top perspective view of an adaptive assembly which can be fitted into the vessel of FIG. 6; and

FIG. 8 is a partial side perspective view, in section, of a reaction vessel made in accordance with a third embodiment of the present invention.

### DETAILED DESCRIPTION

The following description relates to certain preferred embodiments of a reaction vessel or cuvette, preferably for use with an automated clinical analyzer. Throughout the course of discussion, it will be readily apparent to one of sufficient skill that there are various modifications and variations which embody the inventive concepts.

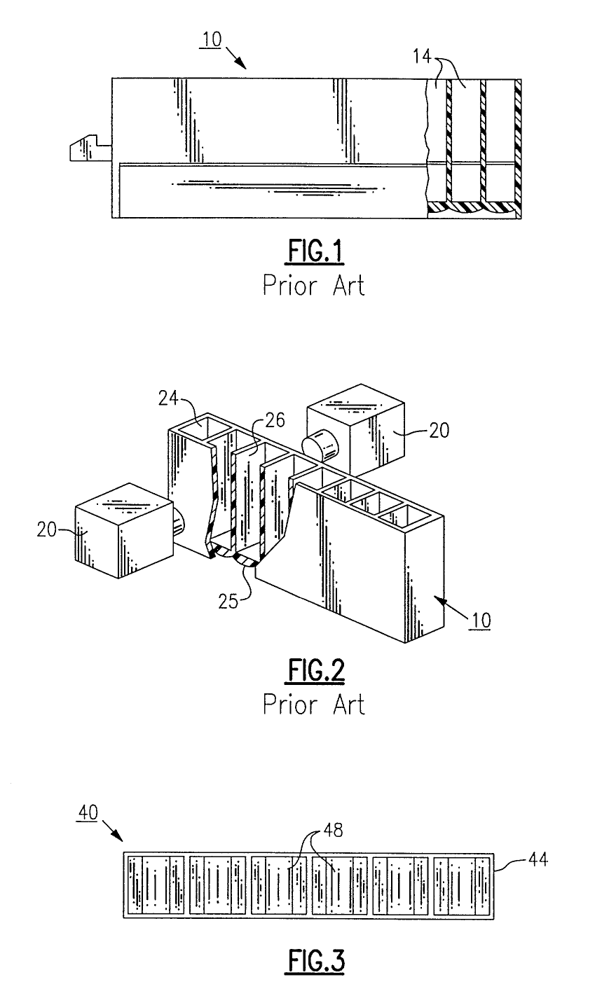

Referring to FIG. 1, and for purposes of background there is first described a prior art reaction vessel 10, the vessel including a plurality of adjacently spaced reaction wells or chambers 14. The vessel 10 permits optical testing of the fluid contents contained within the reaction wells 14 using an apparatus 20, which according to this embodiment is a spectrophotometer or other device capable of measuring an optical property through the side walls of the vessel. Each of the reaction wells 14 of the vessel 10 are generally uniform rectangular sections which include an open top or upper end 24 and a bottom wall 25, each of the reaction wells being separated from one another by respective walls 26 of plastic material.

Referring now to FIGS. 3-5, there is described a reaction vessel 40 made in accordance with a first preferred embodiment of the present invention. The reaction vessel 40 includes a support frame 44, manufactured preferably from a moldable plastic such as polystyrene, acrylic, polyamide, polycarbonate, or other similar material. Though plastic makes the cuvette 40, the vessel could also be made from other materials such as glass or metal. The support frame 44 includes a plurality of adjacent open-ended reaction wells or chambers 48, each of which in a preferred embodiment are equally spaced in relation to one another. According to the present embodiment, six (6) reaction chambers 48 are provided, though it will be appreciated that this number can be suitably varied depending on the application or use of the vessel.

The support frame 44 according to this particular embodiment is rectangular in shape and defined by a pair of side walls 52, and a pair of opposing end walls 56. Each of the reaction chambers 48 are defined by a substantially cylindrical cross section and include an open-ended upper portion 64 and a narrower lower portion 68 including a bottom wall 60. The upper and lower portions 64, 68 of each interior reaction chamber 48 include interior opposing end walls 69 which are substantially parallel to one another, with the exception of a tapered portion 72 linking the upper and lower portions together. The exterior reaction chambers of the vessel 40 include one interior end wall 69 and an end wall 56. In addition, the reaction chambers 48 according to this present embodiment are sized to accommodate a fluid aspirating/dispensing member 76. In this instance, the fluid aspirating/dispensing member 76 is a tapered disposable metering tip 76, such as those manufactured by Johnson and Johnson Company under the trade name Vitros though it should be apparent to one of sufficient skill that other forms of pipette tips can alternately be substituted using the inventive concepts of the invention.

It should or will become readily apparent that the need for the tapered portion 72 is based, in large part, on the geometry of the tip 76 and is not essential if other tips are used. Furthermore, other shapes of the vessel 40 could be assumed rather than only rectangular.

The end walls 56, 69 of each of the reaction chambers 48 are thickened to support the weight of the fluid volume and are formed using conventional molding techniques. In addition, the side walls 52 of the plastic support frame 44 of the herein described reaction vessel 40 also form the side walls for each of the reaction chambers 48. At least a portion 82 of each of the side walls 52 is made optically transparent to permit light to be transmitted through the lower portion 68 of each reaction chamber 48 and permit optical testing of a retained fluid sample, using for example, a spectrophotometer, such as that shown partially in FIG. 2, above. Details relating to this form of testing are provided in U.S. Pat. No. 4,690,900, the entire contents of which are incorporated herein. The entirety of the support frame 44, including the interior end walls 69 are preferably transparent, though it should be realized that this is not essential. In fact, if required, each of the interior end walls 69 or other portions of the vessel could be made to form a light lock to prevent light transmissibility between interior chambers 48.

Due to the disparity in size between that of the narrowed lower portion 68 and the upper portion 64 of each of the reaction chambers 48 according to this embodiment, a gap region 78 is formed between each pair of adjacent interior reaction chambers 48. According to the present embodiment, a total of five (5) gap regions 78 are provided, each having a tapered shape or cross section. In addition, smaller gap regions 75 are provided between each of the end walls 56 and each end reaction chamber 48.

According to this embodiment, the disposable metering tip 76 can aspirate patient sample from a supply (not shown) through use of a conventional metering system (not shown) including a probocsis and a metering transport rail. Alternately, the sample could be supplied manually. The tip 76 can then be placed directly into a reaction chamber 48 such that the dispense end of the tip is placed directly into the lower portion 68 for dispensing of the liquid. The tip 76 can then be withdrawn and discarded or washed. A new tip (not shown) can then aspirate additional fluids, such as reagent or calibration fluids which can also be dispensed into the reaction well 48 for conduction of the assay. The cuvette 40 can then be inserted into an incubator (not shown) and the fluid contents can be optically read in accordance to the protocol of the assay being performed.

The present reaction vessel 40 is a single use cuvette. Therefore, the reaction vessel 40, following conduction of the multiple assays and testing thereof, can be discarded.

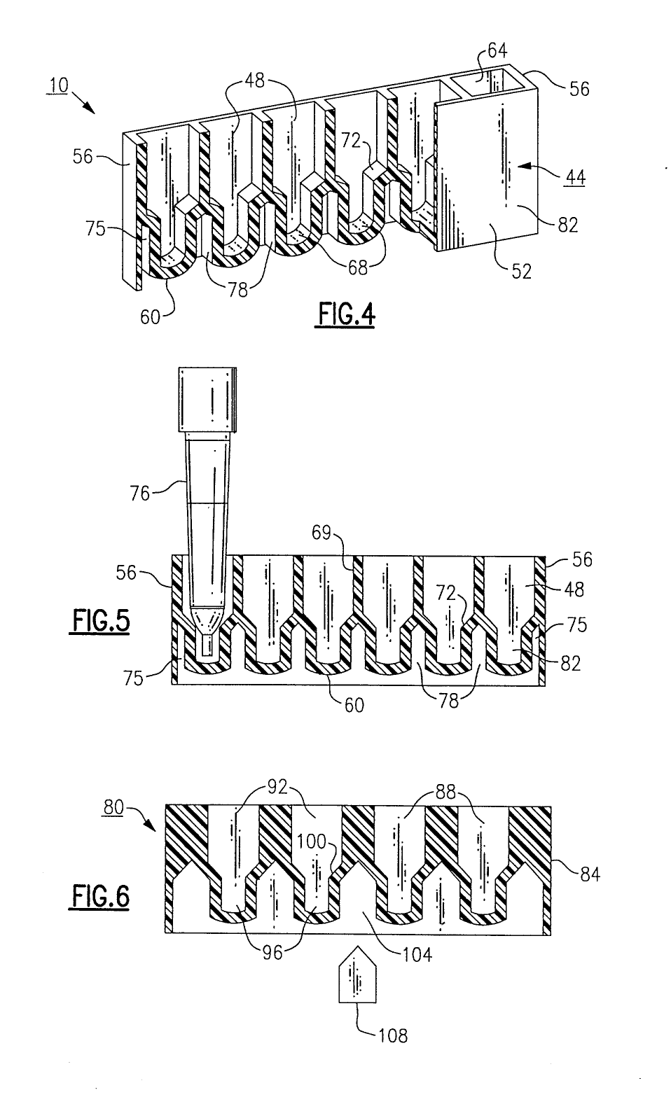

It should be noted that the gap regions can assume other geometries, such as those shown in FIGS. 6 and 7, among others. It should be readily apparent that these illustrations are not exhaustive as numerous gap designs are possible.

Referring back to FIGS. 3-5, the gap regions 78 of the herein described reaction vessel 40 contain air which serves to insulate the contents between adjacent lower portions 68 of the reaction chambers 48 of the reaction vessel 40.

Alternately, each of the gap regions 78 could be evacuated in order to create a vacuum to vary the amount of thermal insulation between adjacent reaction chambers 48.

The smaller gap regions 75 serve a separate function to thermally isolate the cuvette from the heated end surfaces of incubator (not shown).

The reaction vessel can also be used to otherwise thermally affect the fluid contents of any of the reaction wells 48. Referring to FIG. 6, a reaction vessel or cuvette 80 made in accordance with a second embodiment of the present invention is herein described. As in the preceding, the reaction vessel 80 includes a support frame 84 which is defined by a plurality of adjacent reaction chambers 88. Each of the reaction chambers 88 are sized to retain a volumetric quantity of fluid and include respective upper and lower portions 92, 96 separated by a tapered portion 100. A number of gap regions 104 are provided between each of the lower portions 96 of the vessel 80.

According to this embodiment, a corresponding number of adapter elements 108 (only one of which is shown) are sized to be fitted within a defined gap region 104 of the reaction vessel 80. Each of the adapter elements 108 are made from copper or other highly thermally conductive material which can be either selectively implanted in order to speed reaction time and/or hasten the temperature in conjunction with an incubator of the clinical analyzer in order to improve processing times.

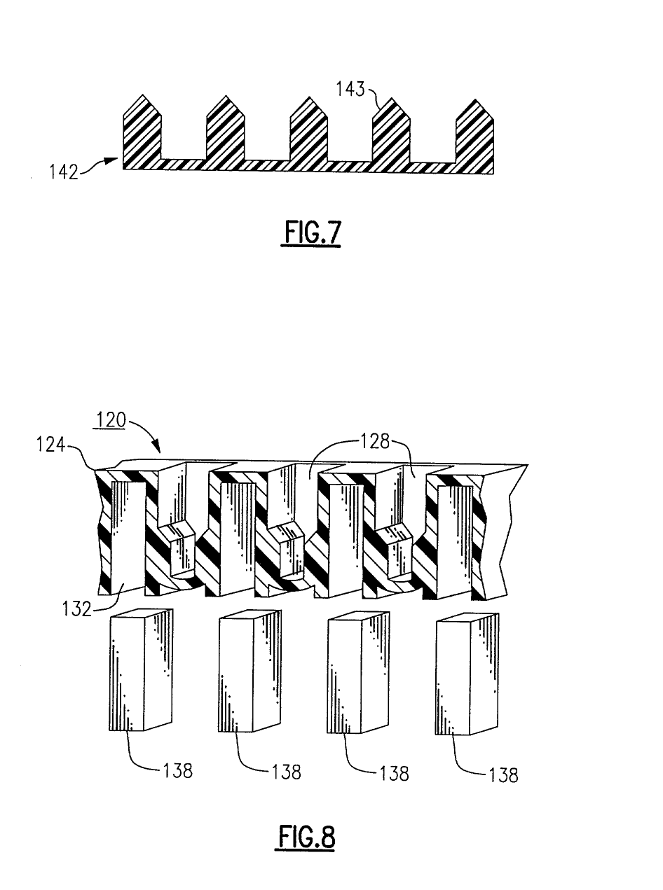

Referring to FIG. 8, a reaction vessel according to a third embodiment is herein described. This reaction vessel 120, as in the preceding embodiments, includes a support frame 124, only partially shown, which includes a plurality of adjacent reaction chambers or wells 128 includes a number of gap regions 132 which according to this embodiment, extend over the entire height of the vessel. The gap regions 132 as shown are air gaps which provide thermal insulation between adjacent reaction wells. However, each of the gap regions 132 could be alternately provided with an adapter element 138 made from a highly thermally conductive material.

### Parts List for FIGS. 1-7

10 reaction vessel

14 frame

18 reaction wells or chambers

20 apparatus

24 open end

26 separating walls

40 reaction vessel

44 support frame

48 reaction chambers or wells

52 side walls

56 end walls

60 bottom wall

64 upper portion

68 lower portion

69 end walls

72 tapered portion

75 gap regions

76 fluid aspirating/dispensing member

78 gap region

80 reaction vessel or cuvette

82 optically transparent portion

84 support frame

88 reaction chambers

92 upper portion

96 lower portion

100 tapered portion

104 gap regions

108 adapter elements

120 reaction vessel

124 support frame

128 reaction chambers or wells

132 gap regions

138 adapter elements

142 adapter plate

143 adapter elements

It should be readily apparent that other modifications and variations are possible which embody the inventive concepts of the invention. For example, and rather than employing insertable or integral adapter elements, a clinical analyzer could include an incubator having a heating plate or plate adaper 142 which engages the gap regions of the reaction vessel as shown in FIG. 7 and whereby any two or more chambers not necessarily adjacent can be thermally connected by appropriately locating the adapter elements 143 on adapter plate 142.

We claim:

1. A reaction vessel comprising:
a frame including a plurality of vertically disposed reaction chambers in spaced relation, each of said reaction chambers being sized for retaining a volume of at least one fluid; and
means disposed between each of said reaction chambers for thermally affecting the fluid contents of at least one adjacent pair of said plurality of reaction chambers.

2. A vessel as recited in claim 1, wherein at least one of said reaction chambers is sized to accommodate a member capable of at least one of aspirating and dispensing a fluid.

3. A vessel as recited in claim 1, wherein each of said reaction chambers are sized to accommodate a member capable of at least one of aspirating and dispensing a fluid.

4. A vessel as recited in claim 2, wherein said member is a metering tip.

5. A vessel as recited in claim 4, wherein said metering tip is disposable.

6. A vessel as recited in claim 1, wherein each of said reaction chambers includes an upper portion and a lower portion, wherein said thermal affecting means includes at least one gap region disposed between at least the lower portions of at least one adjacent pair of reaction chambers.

7. A vessel as recited in claim 1, wherein said thermal affecting means includes thermal insulating means for insulating the fluid contents of at least one adjacent pair of reaction chambers.

8. A vessel as recited in claim 7, wherein said thermal insulating means includes at least one gap region disposed between said at least one adjacent pair of reaction chambers.

9. A vessel as recited in claim 8, wherein said at least one gap region includes at least one air gap.

10. A vessel as recited in claim 1, wherein said frame is made from plastic.

11. A vessel as recited in claim 1, wherein said frame is substantially rectangular.

12. A vessel as recited in claim 6, wherein said frame is substantially rectangular, said frame being defined by a pair of opposing side walls and a pair of opposing end walls.

13. A vessel as recited in claim 12, wherein each of the upper and lower sections of each reaction chamber includes a pair of side walls, wherein the spacing between said side walls of said lower portion is narrower than the spacing between the side walls of the upper portion.

14. A vessel as recited in claim 13, wherein the side walls of said lower portion are substantially parallel and at least a portion of the side walls of the upper portion are parallel.

15. A vessel as recited in claim 6, wherein said thermal affecting means includes thermal conducting means for conducting heat to the contents of at least one pair of reaction chambers, said thermal conducting means being positioned into said at least one gap region.

16. A vessel as recited in claim 15, wherein said thermal conducting means includes at least one thermally conductive member sized for fitting in a gap region between adjacent reaction chambers.

17. A vessel as recited in claim 16, wherein said thermally conductive element is made from highly thermally conductive material.

18. A vessel as recited in claim 16, wherein said thermally conductive element is removable from said gap region.

19. A vessel as recited in claim 14, wherein a portion of said side walls are tapered between the upper and lower portion of each reaction chamber.

20. A vessel as recited in claim 19, wherein each of the reaction chambers are sized to accommodate a tapered metering tip, said tip being capable of at least one of dispensing and aspirating liquid from a lower portion thereof.

21. A vessel as recited in claim 1, wherein at least a portion of each of said reaction chambers includes at least one optically transmissive window.

22. A vessel as recited in claim 21, wherein said at least one optically transmissive window is disposed in a lower portion of at least one reaction chamber.

23. A vessel as recited in claim 1, wherein said vessel is disposable.

24. A vessel as recited in claim 4, wherein said metering tip is non-disposable.

25. A vessel as recited in claim 1, wherein said vessel is washable.

26. A vessel as recited in claim 21, including a pair of optically transmissive windows are disposed over at least a portion of opposing portions of at least one reaction chamber.

27. A vessel as recited in claim 6, including gap regions disposed between opposing end wells of said frame and an interior reaction chamber.

28. A vessel for use in a clinical analyzer, said reaction vessel comprising:
a frame including a plurality of vertically disposed reaction chambers in spaced relation, each of said reaction chambers being sized for retaining a volume of at least one fluid, and means disposed between each of said chambers for thermally insulating the fluid contents of at least one pair of said plurality of reaction chambers.

29. A vessel as recited in claim 28, wherein at least one of said reaction chambers is sized to accommodate a member capable of at least one of aspirating and dispensing a fluid.

30. A vessel as recited in claim 28, wherein each of said reaction chambers are sized to accommodate a member capable of at least one of aspirating and dispensing a fluid.

31. A vessel as recited in claim 29, wherein said fluid dispensing member is a metering tip.

32. A vessel as recited in claim 31, wherein said metering tip is disposable.

33. A vessel as recited in claim 28, wherein each of said reaction chambers includes an upper portion and a lower portion, wherein said thermal insulating means includes at least one gap region disposed between at least the lower portions of at least one pair of adjacent reaction chambers.

34. A vessel as recited in claim 30, wherein said at least one gap region includes at least one air gap.

35. A vessel as recited in claim 28, wherein said frame is made from plastic.

36. A vessel as recited in claim 28, wherein said frame is substantially rectangular.

37. A vessel as recited in claim 33, wherein said frame is substantially rectangular, said frame being defined by a pair of opposing side walls and a pair of opposing end walls.

38. A vessel as recited in claim 37, wherein each of the upper and lower sections of each reaction chamber includes a pair of side walls, wherein the spacing between said side walls of said lower portion is narrower than the spacing between the side walls of the upper portion.

39. A vessel as recited in claim 38, wherein the side walls of said lower portion are substantially parallel and at least a portion of the side walls of the upper portion are parallel.

40. A vessel as recited in claim 39, wherein a portion of said side walls are tapered between the upper and lower portion of each reaction chamber.

41. A vessel as recited in claim 40, wherein each of the reaction chambers are sized to accommodate a tapered metering tip, said tip being capable of at least one of dispensing and aspirating liquid from at least the lower portion of said chamber.

42. A vessel as recited in claim 28, wherein at least a portion of at least one reaction chamber includes at least one optically transmissive window.

43. A vessel as recited in claim 42, wherein said at least one optically transmissive window is disposed in a lower portion of at least one reaction chamber.

44. A vessel as recited in claim 24, wherein said vessel is disposable.

45. A vessel as recited in claim 31, wherein said metering tip is non-disposable.

46. A vessel as recited in claim 28 wherein said vessel is washable.

47. A vessel as recited in claim 42, including a pair of optically transmissive windows are disposed over at least a portion of opposing portions of at least one reaction chamber.

48. A vessel as recited in claim 33, including gap regions disposed between opposing end wells of said frame and an interior reaction chamber.

49. A clinical analyzer comprising:
an incubator;
at least one test station; and
a reaction vessel comprising a frame including a plurality of vertically disposed reaction chambers in spaced relation, each of said reaction chambers being sized for retaining a volume of at least one fluid, and means disposed between each of said chambers for thermally affecting the fluid contents of at least one pair of said plurality of reaction chambers.

50. An analyzer as recited in claim 49, wherein said reaction vessel is sized to fit within said incubator.

51. An analyzer as recited in claim 49, including metering means for metering a quantity of sample fluid into said reaction vessel from a fluid supply, said reaction chambers being sized to accommodate a fluid dispensing or aspirating member.

52. An analyzer as recited in claim 51, wherein said fluid dispensing or aspirating member is a tapered metering tip.

53. An analyzer as recited in claim 49, including testing means for evaluating the fluid contents of at least one reaction chamber.

54. An analyzer as recited in claim 53, wherein said testing means includes optical testing means, at least a portion of at least one reaction chamber of said vessel including at least on optically transmissive window.

55. An analyzer as recited in claim 49, wherein said thermal affecting means includes at least one gap region interposed between at least two adjacent reaction chambers.

56. An analyzer as recited in claim 55, wherein each of said reaction chambers includes an upper portion and a lower portion, and in which said at least one gap region is interposed at least between adjacent lower portions.

57. An analyzer as recited in claim 49, wherein said thermal affecting means includes thermal insulating means for insulating the fluid contents of at least one adjacent pair of reaction chambers.

58. An analyzer as recited in claim 57, wherein said thermal insulating means includes at least one gap region disposed between said at least one adjacent pair of reaction chambers.

59. An analyzer as recited in claim 58, wherein said at least one gap region includes at least one air gap.

60. An analyzer as recited in claim 49, wherein said frame of said reaction vessel is made of plastic.

61. An analyzer as recited in claim 49, wherein said thermal affecting means includes thermal conducting means for conducting heat from said incubator to the interior of at least one pair of reaction chambers, said thermal conducting means including at least one gap region disposed between said at least one adjacent pair of reaction chambers.

62. An analyzer as recited in claim 61, wherein said thermal conducting means further includes at least on thermally conductive member sized for fitting in a gap region between adjacent reaction chambers.

63. An analyzer as recited in claim 62, wherein said thermally conductive element is removable from said gap region.

64. An analyzer as recited in claim 49, wherein said reaction vessel is disposable.

65. An analyzer as recited in claim 52, wherein said metering tip is disposable.

66. An analyzer as recited in claim 52, wherein said metering tip is non-disposable.

67. A vessel as recited in claim 49, wherein said vessel is washable.

68. A vessel as recited in claim 54, including a pair of optically transmissive windows are disposed over at least a portion of opposing portions of at least one reaction chamber.

69. A vessel as recited in claim 61, including gap regions disposed between opposing end wells of said frame and an interior reaction chamber.

70. A method for testing a patient sample, said method comprising the steps of:
providing a reaction vessel having a plurality of adjacent reaction chambers,
aspirating a fluid into a fluid aspirating/dispensing member;
placing said fluid aspirating/dispensing member into a lower portion of a reaction chamber; and
dispensing fluid directly into the lower portion of the reaction chamber of said vessel, and heating said reaction vessel, wherein said reaction vessel includes thermal affecting means for thermally affecting the fluid contents of at least one adjacent pair of reaction chambers during said heating step.

71. A method as recited in claim 70, wherein said fluid aspirating/dispensing member is a pipette tip.

72. A method as recited in claim 71, wherein said pipette tip includes a dispense end, said method including the step of positioning said dispense end into said lower portion of said reaction chamber.

73. A method as recited in claim 72, wherein said thermal affecting means includes at least one gap region disposed between at least one pair of reaction chambers for insulating the contents of said reaction chambers during said heating step.

74. A method as recited in claim 73, including at least one thermal conducting element sized to be fitted into at least one gap region for promoting thermal flow during said heating step.
